(19) United States
(12) Patent Application Publication
(10) Pub. No.: US 2009/0221296 A1
(43) Pub. Date: Sep. 3, 2009

(54) Communication terminal, network server, and communication network system

(75) Inventor: Akira Hioki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/320,982

(22) Filed: Feb. 10, 2009

(30) Foreign Application Priority Data
Feb. 28, 2008 (JP) 47164/2008

(51) Int. Cl. H04W 72/00

(52) U.S. Cl. 455/452.1

(57) ABSTRACT

Provided is a communication network system capable of effectively utilizing a telephone number and a terminal identity assigned to a communication terminal. The communication terminal transmits to a network server a communication start request including a temporary telephone number and a mobile station identity which are previously permitted to use. The network server verifies the communication terminal based on the mobile station identity. At this point, the network server informs the communication terminal of the telephone number necessary for the communication terminal to continue communication. The communication terminal originates a call by using the telephone number and the mobile station identity.

### BACKGROUND OF THE INVENTION

1. Field of the Invention

The present invention relates to a communication network system where a network server dynamically assigns a telephone number and a terminal identity to a communication terminal.

2. Description of Related Art

FIG. 6 shows a system for assigning a telephone number used in the current mobile communication system in Japan. As shown in FIG. 6, at least one eleven-digit telephone number formed of a three-digit service identification number “XXX” (“090” or “080”) and an eight-digit subscriber number “YYYYYYYY” is fixedly assigned to a mobile phone terminal.

Moreover, although not illustrated, a mobile station identity (MSI, which may hereinafter be referred to as a terminal identity) represented as the finite number of digits is fixedly assigned to a mobile phone terminal. Use of the mobile station identity enables a network server to determine (verify) whether or not a mobile phone terminal is under official contract even when a subscriber has changed mobile network operators by using a mobile number portability (MNP) service.

Since a telephone number and a mobile station identity need to be fixedly assigned to a mobile phone terminal in the current mobile communication system, it is concerned that telephone numbers may run out with increase in the number of subscribers or that mobile station identities may run out with increase in the number of MNP service users.

As a countermeasure against this problem, there is a proposal to increase the number of digits of a telephone number or a mobile station identity. However, with increase in the number of digits, there will be a need to reconstruct a communication infrastructure, make adaptations on a mobile phone terminal, and the like. Therefore, it is difficult to implement the proposal.

Meanwhile, Japanese Patent Application Publication No. 2002-261935 describes a telephone number distribution system as follows. In this system, a temporary telephone number is issued to a telephone terminal while the temporary telephone number is associated with a telephone number fixedly assigned to the telephone terminal. Then, a telephone call made by another telephone terminal using the temporary telephone number is transferred to the telephone terminal. However, this system is simply for hiding a true telephone number and preventing others from maliciously using the true telephone number. For this reason, this system is not capable of solving the above-described problem at all.

A communication terminal according to an aspect of the present invention includes: first means for transmitting to a network a communication start request having a first telephone number and a first terminal identity which are previously permitted to use; and second means for originating a call by using a second telephone number or a second terminal identity which has been received as a response to the communication start request and is necessary to continue communication.

Furthermore, a network server according another aspect of the present invention includes: first means for verifying a communication terminal based on a first terminal identity in response to a communication start request of the communication terminal, the request including a first telephone number and the first terminal identity which are previously permitted to use; and second means for informing the communication terminal of a second telephone number or a second terminal identity which is necessary for the communication terminal to continue communication, in accordance with the verification of the communication terminal.

Moreover, a communication network system according to another aspect of the present invention includes: a communication terminal for transmitting a communication start request having a first telephone number and a first terminal identity which are previously permitted to use; and a network server for verifying the communication terminal based on the first terminal identity in response to the communication start request and informing the communication terminal of a second telephone number or a second terminal identity which is necessary for the communication terminal to continue communication, in accordance with the verification of the communication terminal.

In other words, according to the present invention, a network server can dynamically assign a telephone number or a terminal identity to a communication terminal, thereby allowing the communication terminal to perform communication.

### SUMMARY

According to the present invention, it is possible to, only when necessary, assign a telephone number and a terminal identity to a communication terminal where the frequency of communication is relatively low (for example, a terminal which downloads debugging software and acquires inventory control information), thereby effectively utilizing a telephone number and a terminal identity.

Furthermore, since there is no need at all to change a system itself of a telephone number and a terminal identity, there is also an advantage that renovation for the existing communication infrastructure and communication terminal is not necessary.

### BRIEF DESCRIPTION OF THE DRAWINGS

FIGS. 1A and 1B are block diagrams showing configuration examples of an embodiment of a communication network system according to the present invention.

FIG. 2 is a sequence diagram showing a first operation example of the embodiment of the communication network system according to the present invention.

FIG. 3 is a sequence diagram showing an example of the establishment of control connection and of security control operations in the embodiment of the communication network system according to the present invention.

FIG. 4 is a view showing a configuration example of a layer 3 processing signal used in the embodiment of the communication network system according to the present invention.

FIG. 5 is a sequence diagram showing a second operation example of the embodiment of the communication network system according to the present invention.

FIG. 6 is a view showing a system to assign a telephone number used in the current mobile communication system in Japan.

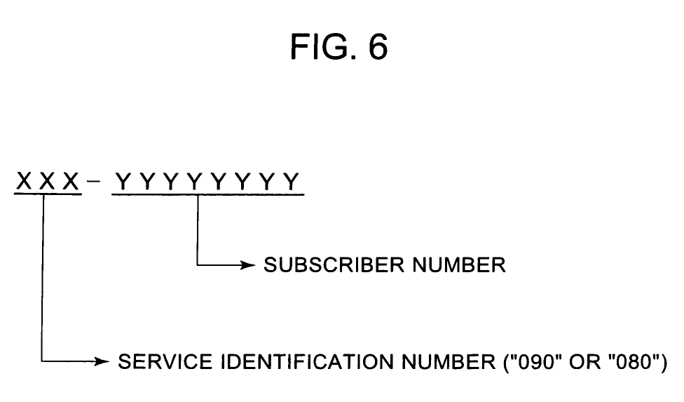

### DETAILED DESCRIPTION OF THE PREFERRED EMBODIMENT

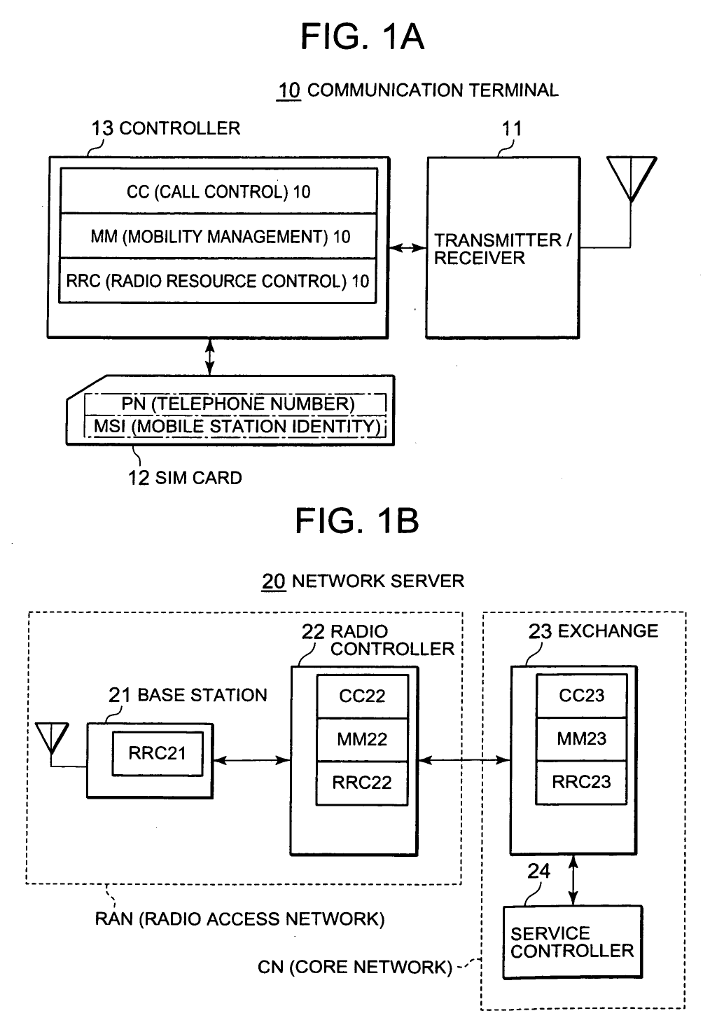

Descriptions will hereinafter be given of an embodiment of a communication network system according to the present invention with reference to FIGS. 1A to 5.

### Configuration Example: FIG. 1

A communication network system according to the embodiment includes: a communication terminal 10 shown in FIG. 1A; and a network server 20 shown in FIG. 1B. The communication terminal 10 includes: a transmitter/receiver 11 being a wireless interface with the network server 20; a SIM card 12 storing in advance a telephone number PN and a mobile station identity MSI; and a controller 13 which requests the network server to start communication via the transmitter/receiver 11, and which continues communication using a telephone number or a mobile station identity informed by the network server 20 as a response to the request.

In addition, the controller 13 includes a layer 3 function defined in a general mobile communication scheme. In other words, as shown in FIG. 1A, the controller 13 includes: a radio resource control (RRC) controlling radio resource such as a wireless carrier and a time slot; a mobility management (MM) managing location registration, cell switching, and the like; and a call control (CC) controlling call connection such as an incoming or outgoing call. Please note that, in the following descriptions, the radio resource control, the mobility management, and the call control in the controller 13 may be represented by codes RRC10, MM10, and CC10, respectively.

On the other hand, as shown in FIG. 1B, the network server 20 includes: a base station 21 and a radio controller 22 which form a radio access network (RAN); and an exchange 23 and a service controller 24 which form a core network (CN).

Moreover, the base station 21, the radio controller 22, and the exchange 23 include radio resource controls RRC21 to RRC23, respectively. The radio controller 22 and the exchange 23 include mobility managements MM22 and MM23, and call controls CC22 and CC23, respectively. Please note that, in the following descriptions, the radio resource controls RRC21 to RRC23, the mobility managements MM22 and MM23, and the call controls CC22 and CC23 may collectively be called codes RRC20, MM20, and CC20, respectively.

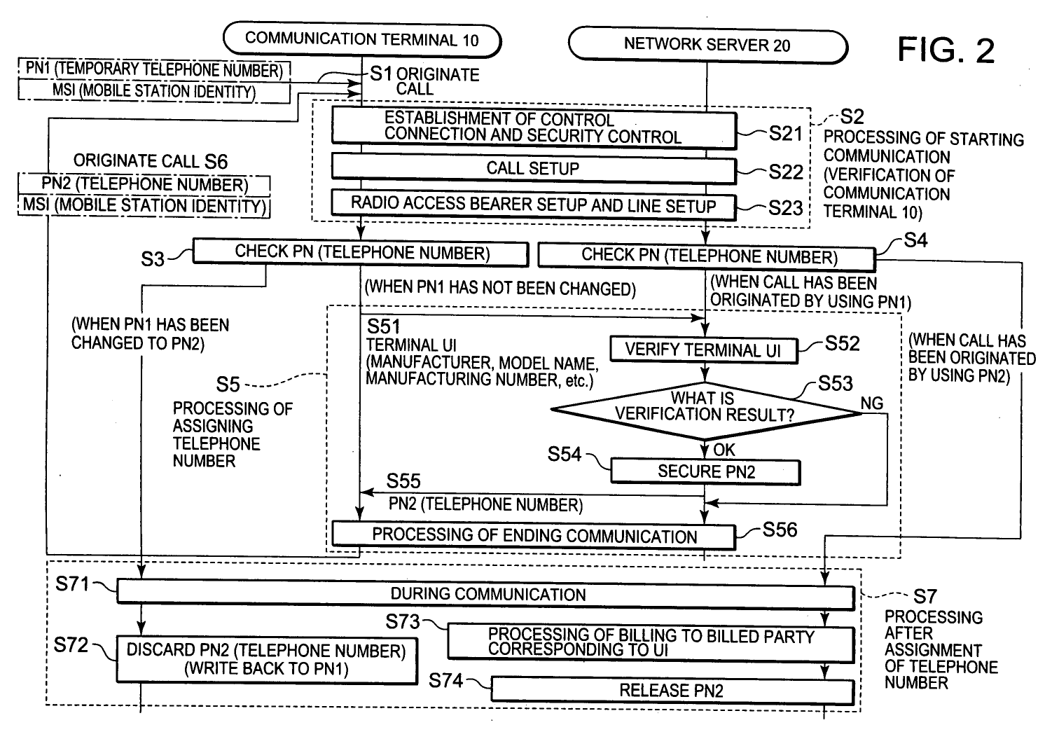

### Operation Examples: FIGS. 2 to 5

Next, descriptions will sequentially be given of a first and a second operation example of the embodiment with reference to FIGS. 2 to 5. Here, the first operation example deals with a case where the network server 20 dynamically assigns a telephone number to the communication terminal 10. Moreover, the second operation example deals with a case where the network server 20 dynamically assigns a mobile station identity to the communication terminal 10.

Please note that each processing in the network server 20 described in the first and the second operation example may be performed singly by any one of the radio controller 22, the exchange 23, and the service controller 24, which are shown in FIG. 1B, or may be performed in cooperation.

### First Operation Example (Dynamic Assignment of Telephone Number): FIGS. 2 to 4

As shown in FIG. 2, the communication terminal 10 (the controller 13) first originates a call using a temporary telephone number PN1 and a mobile station identity MSI assigned fixedly thereto, and then requests the network server 20 to start communication (Step S1). Here, it is sufficient if a value that the network server 20 can at least recognize the communication terminal 10 as a terminal which requests dynamic allocation of a telephone number is set for the temporary telephone number PN1. For example, it is possible to cause the communication terminal 10 to share the same telephone number with another communication terminal as the temporary telephone number.

Communication start processing is then performed by mutual operations of the communication terminal 10 and the network service 20, and the communication terminal 10 is verified (Step S2). Moreover, in the communication start processing, the establishment of control connection and security control (Step S21), a call setup (Step S22), and a radio access bearer setup and a line setup (Step S23) are performed as illustrated in FIG. 2.

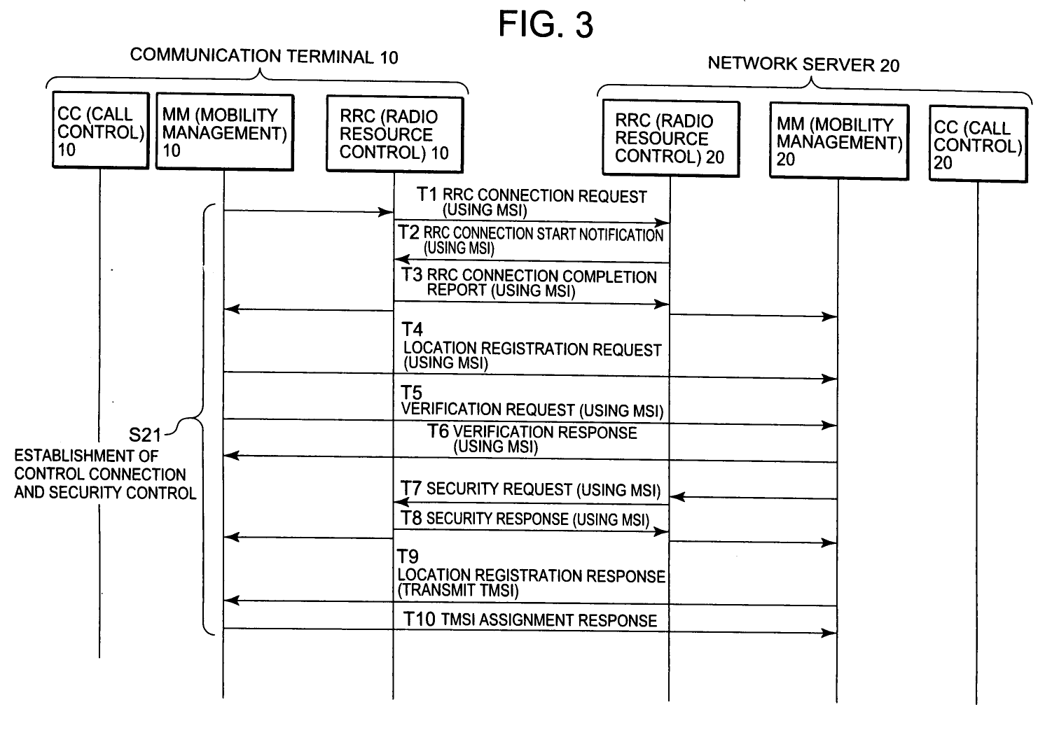

In other words, as shown in FIG. 3, the radio resource control RRC 10 in the communication terminal 10 transmits an RRC connection request (a signal) to the radio resource control RRC20 in the network server 20 (Step T1). The radio resource control RRC20 transmits RRC connection start notification to the radio resource control RRC10 (Step T2). In response to this, the radio resource control RRC10 transmits an RRC connection completion report to the radio resource control RRC20 (Step T3). These Steps T1 to T3 make it possible to establish control connection between the communication terminal 10 and the network server 20, thereby transmitting and receiving control information.

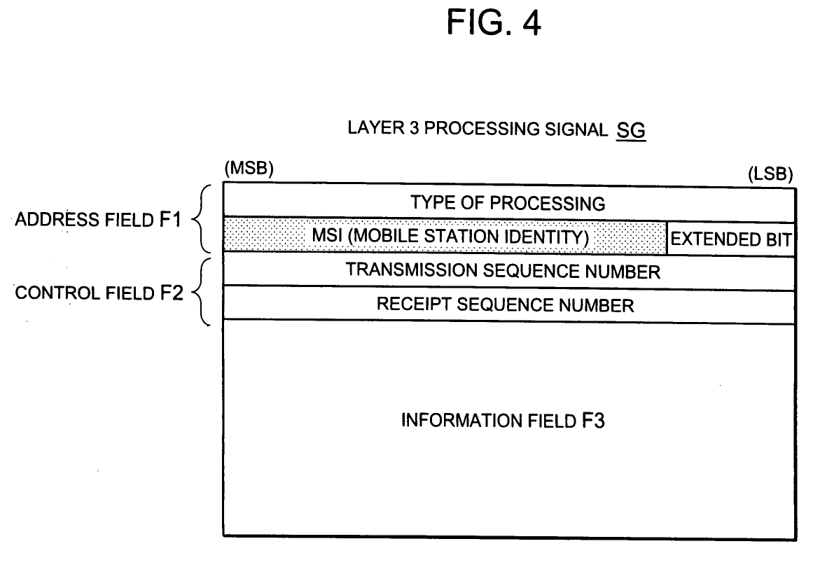

Here, as shown in FIG. 4, a signal SG processed at a layer 3, is approximately composed of an address field F1, a control field F2, and an information field F3. In the address field F1, the type of processing at the layer 3 and the mobile station identity MSI are stored, and an extended bit for absorbing the system dependency of an MSI bit length is provided. Furthermore, in the control field F2, a transmission sequence number and a receipt sequence number for making it possible to control the order of signals SG are stored, and in the information field F3, various types of information used at the layer 3 are stored.

The mobility management MM10 in the communication terminal 10 which detected the establishment of control connection requests the mobility management MM20 in the network server 20 to register the location (Step T4). Additionally, in order to ensure the security of the control connection, verification between the mobility managements MM10 and MM20 is performed (Steps T5 and T6), and security control between the radio resource control RRC10 and RRC20 is performed (Steps T7 and T8).

Moreover, the network server 20 recognizes that the communication terminal 10 is a valid terminal (a contract terminal) when receiving a security response from the communication terminal 10 in the above Step T8.

Afterwards, the mobility management MM20 transmits a location registration response to the mobility management MM10. However, at this point, the mobility management MM20 uses a temporary MSI (TMSI) instead of the mobile station identity MSI as illustrated in FIG. 3 (Step T9). The TMSI is for being temporarily assigned for the purpose of improving the efficiency of subsequent communication (reducing the amount of information (bit length)) while being associated with the mobile station identity MSI. The mobility management MM10 transmits a TMSI assignment response to the mobility management MM20 (Step T10) Returning to FIG. 2, a call setup between the communication terminal 10 and the network server 20 (Step S22), a radio access bearer setup in radio sections, and a line setup based on a connection destination number (unillustrated) and the like (Step S23) are performed by mutual operations of the communication terminal 10 and the network server 20. Consequently, communication between the communication terminal 10 and the network sever 20 becomes possible.

The communication terminal 10 then checks whether or not the temporary telephone number PN1 has been changed (that is, whether or not a new telephone number has been assigned by the network server 20) (Step S3). At this point, the temporary telephone number PN1 has not been changed. Therefore, the communication terminal 10 performs the processing of assigning a telephone number shown in Step S5. Furthermore, the network server 20 checks whether or not a telephone number that the communication terminal 10 used to originate a call is the temporary telephone number PN1 (Step S4), and again, the processing goes to Step S5 to perform the processing of assigning a telephone number.

Specifically, the communication terminal 10 first transmits information UI unique to its own terminal (for example, a manufacturer, a model name, and a manufacturing number) to the network server 20 (Step S51). The network server 20 verifies the terminal unique information UI using information previously acquired from a manufacturer of the communication terminal 10 and the like (Step S52).

If the verification result is “OK” (Step S53), the network server 20 secures a telephone number PN2 for causing the communication terminal 10 to continue communication (Step S54), and informs the communication terminal 10 of the telephone number PN2 (Step S55). Here, the telephone number PN2 is one of the finite number of telephone numbers prepared in advance at the network server 20 (a number smaller than the number of communication terminals using the network server 20) Please note that the network server 20 informs the communication terminal 10 of guidance such as originating a call again later when failing to secure a telephone number.

Then, the communication terminal 10 and the network server 20 complete the communication once after performing the specified processing of ending communication (Step S56). Please note that if the verification result is “NG” in the above Step S53, securing and informing a telephone number are not performed in the above Steps S54 and S55, respectively.

After the communication terminal 10 saves the original telephone number PN1 in memory (unillustrated) and the like, a call is originated again by using the telephone number PN2 informed in the above Step S55 and the mobile station identity MSI (Step S6). Accordingly, the communication terminal 10 is verified in the above Step S2. In this case, since the telephone number has been changed from PN1 to PN2 (in other words, since the network server 20 already assigned to the communication terminal 10 the telephone number PN2 instead of the temporary telephone number PN1, and the communication terminal 10 originated a call by using the assigned telephone number PN2), the communication terminal 10 and the network server 20 continue communication without performing the processing of assigning a telephone number as shown in the above Step S5 (shift during communication) (Step S71).

When the communication ends, the communication terminal 10 discards the telephone number PN2 (writes a telephone number used for originating a call back to PN1 saved) (Step S72).

In addition, the network sever 20 records a communication charge to a billed party corresponding to the terminal unique information UI previously designated by a manufacturer of the communication terminal 10 and the like (Step S73). Consequently, it is possible to securely bill a communication charge even if a telephone number is dynamically assigned to the communication terminal 10.

In addition, the network server 20 releases the telephone number PN2 secured in the above Step S54 (makes reassignment to another communication terminal possible) (Step S74). Consequently, it is possible to effectively use the finite number of telephone numbers.

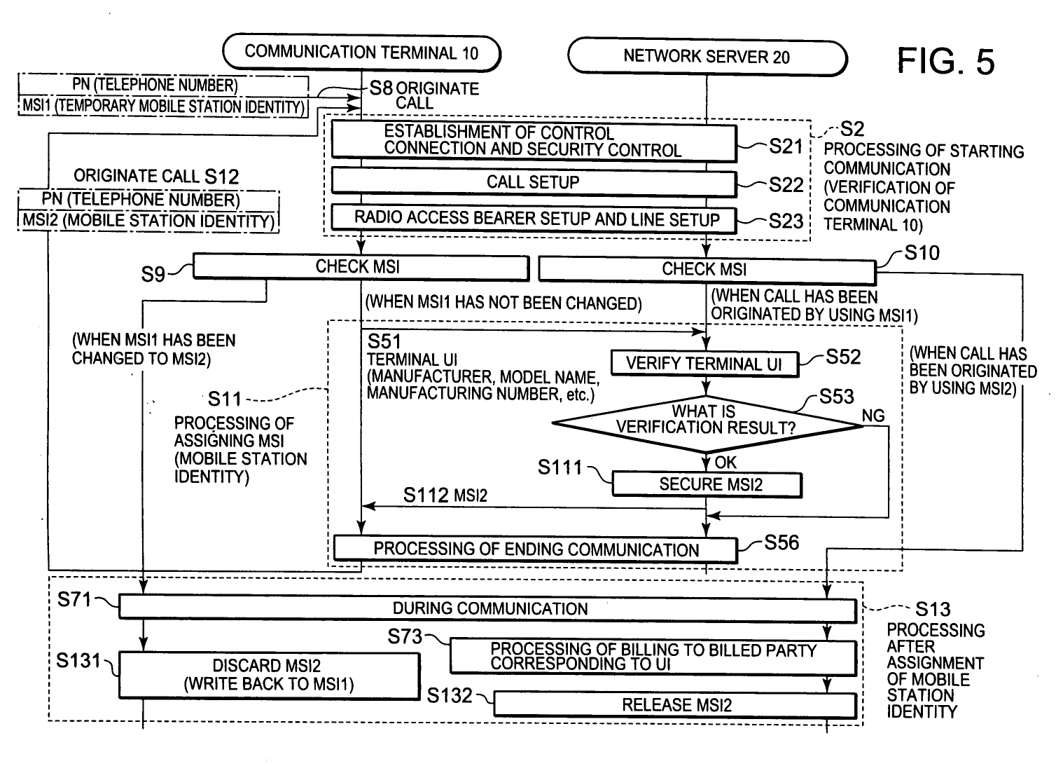

### Second Operation Example (Dynamic Assignment of Mobile Station Identity): FIG. 5

As shown in FIG. 5, the communication terminal 10 first originates a call by using the telephone number PN assigned fixedly thereto and a temporary mobile station identity MSI1, and requests the network server 20 to start communication (Step S8). Here, it is sufficient if a value is set for the temporary mobile station identity MSI1 so that the network server 20 can recognize the communication terminal 10 as a terminal which requests dynamic allocation of a mobile station identity and can normally perform communication start processing similar to Step S2 (please refer to FIG. 2) shown in the above first operation example. For example, it is possible to cause the communication terminal 10 to share the same mobile station identity with another communication terminal as the temporary mobile station identity MSI1.

The communication terminal 10 and the network server 20 then check whether or not the temporary mobile station identity MSI1 has been changed, respectively, unlike the above Steps S3 and S4 (Steps S9 and S10), as well as going to Step S11 to perform the processing of assigning a mobile station identity. Please note that although not illustrated, the network server 20 checks (determines) whether or not a telephone number used to originate a call is the telephone number PN in parallel with the above Step S10.

In other words, similarly to the above Steps S51 and S52, the communication terminal 10 transmits the terminal unique information UI to the network server 20, and the network server 20 verifies the information.

If the verification result is “OK”, the network server 20 secures a mobile station identity MSI2 and informs the communication terminal 10 of the mobile station identity MSI2, unlike the above Steps S54 and S55 (Steps S111 and S112). Here, the mobile station identity MSI2 is one of the finite number of mobile station identities prepared in advance at the network server 20, similarly to the telephone number shown in the above first operation example.

Then, the communication terminal 10 and the network server 20 complete the communication once, similarly to the above Step S56. The communication terminal 10 originates a call again using the telephone number PN and the mobile station identity MSI2 (Step S12). Consequently, both of the communication terminal 10 and the network server 20 shift during communication, similarly to the above Step S71.

When the communication ends, the communication terminal 10 discards the mobile station identity MSI2 (Step S131). In addition, the network server 20 releases the mobile station identity MSI2 after recording a communication charge similarly to the above Step S73 (Step S132). Consequently, even if a mobile station identity is dynamically assigned to the communication terminal 10, it is possible to securely bill a communication charge and effectively use the finite number of mobile station identities.

Although the inventions has been described above in connection with several preferred embodiments thereof, it will be appreciated by those skilled in the art that those embodiments are provided solely for illustrating the invention, and should not be relied upon to construe the appended claims in a limiting sense.

For example, it is also possible to provide the present invention as a program for causing a computer to execute each processing of a communication terminal and a network server as shown in the above embodiment.

What is claimed is:

1. A communication terminal comprising:
first means for transmitting to a network a communication start request including a first telephone number and a first terminal identity which are previously permitted to use; and
second means for originating a call by using any one of a second telephone number and a second terminal identity which has been received as a response to said communication start request and is necessary to continue communication.

2. The communication terminal according to claim 1, wherein said first means includes its own unique information in said communication start request.

3. The communication terminal according to claims 1, further comprising:
means for discarding the one of said second telephone number and said second terminal identity after the end of communication.

4. A network server comprising:
first means for verifying a communication terminal based on a first terminal identity of said communication terminal in response to a communication start request of said communication terminal, said request including a first telephone number and said first terminal identity which are previously permitted to use; and
second means for informing said communication terminal of any one of a second telephone number and a second terminal identity which is necessary for said communication terminal to continue communication, in accordance with said verification of said communication terminal.

5. The network server according to claim 4, wherein
said communication start request includes unique information to said communication terminal, and
said first means verifies said communication terminal by using said unique information in addition to said first terminal identity.

6. The network server according to claim 5, further comprising:
means for recording a communication charge generated by communication with said communication terminal, in association with said unique information.

7. The network server according to claim 4, further comprising:
means for releasing the one of said second telephone number and said second terminal identity after the end of communication with said communication terminal, wherein said second means includes means for capturing the one of said second telephone number and said second terminal identity from among the finite number of telephone numbers or terminal identities.

8. A communication network system comprising:
a communication terminal for transmitting a communication start request including a first telephone number and a first terminal identity which are previously permitted to use; and
a network server for verifying said communication terminal based on said first terminal identity in response to said communication start request and informing said communication terminal of any one of a second telephone number and a second terminal identity which is necessary for said communication terminal to continue communication, in accordance with said verification of said communication terminal.

9. The communication network system according to claim 8, wherein
said communication terminal includes its own unique information in said communication start request, and
said network server verifies said communication terminal by using said unique information in addition to said first terminal identity.

10. The communication network system according to claim 9, wherein said network server records a communication charge generated by communication with said communication terminal, in association with said unique information.

11. The communication network system according to claim 8, wherein said network server captures the one of said second telephone number and said second terminal identity from among the finite number of telephone numbers or terminal identities, and releases the one of said second telephone number and said second terminal identity after the end of communication with said communication terminal.
